(19) United States
(12) Patent Application Publication
(10) Pub. No.: US 2013/0082028 A1
(43) Pub. Date: Apr. 4, 2013

(54) FORMING A PLANAR FILM OVER MICROFLUIDIC DEVICE OPENINGS

(71) Applicants: EMMANUEL K. DOKYI, Rochester, NY (US); John Andrew Lebens, Rush, NY (US); Weibin Zhang, Pittsford, NY (US)

(72) Inventors: EMMANUEL K. DOKYI, Rochester, NY (US); John Andrew Lebens, Rush, NY (US); Weibin Zhang, Pittsford, NY (US)

(21) Appl. No.: 13/249,299

(22) Filed: Sep. 30, 2011

(51) Int. Cl. B41J 2/16

(52) U.S. Cl. 216/27

(57) ABSTRACT

A method of fabricating a microfluidic device, the method includes etching a plurality of frame-shaped grooves into a first side of a substrate, each frame-shaped groove surrounding a non-etched portion of the substrate; dispensing a sacrificial photoresist on the first side of the substrate; spinning the wafer to obtain a substantially planar surface of the sacrificial photoresist; patterning the sacrificial photoresist to form openings defining walls for a plurality of chambers and fluid passageways; laminating a polymer film over the patterned sacrificial photoresist; etching a portion of the substrate from a second side of the substrate until the etched portion meets the frame-shaped grooves; removing the sacrificial resist to provide a plurality of chambers, each chamber being adjacent to at least one of the plurality of walls; and removing the non-etched portions of the substrate surrounded by the frame-shaped grooves to form a plurality of feed holes.

### CROSS REFERENCE TO RELATED APPLICATIONS

Reference is made to commonly assigned, concurrently filed and co-pending U.S. patent application Ser. No. ______ (K000437), filed herewith, entitled “Liquid Ejection Device With Planarized Nozzle Plate,” the disclosure of which is incorporated herein.

### FIELD OF THE INVENTION

The present invention relates generally to a polymer film in a microfluidic device and, more particularly, to a polymer film that is substantially planarized over an opening in the microfluidic device.

### BACKGROUND OF THE INVENTION

Microfluidic devices are used in a wide range of fields for precise control and manipulation of fluids that are geometrically constrained to a small, typically sub-millimeter, scale. Microfluidic structures include microsystems for the handling of off-chip fluids (e.g liquid pumps, gas valves), as well as structures for the on-chip handling of nano- and picoliter volumes. To date, the most successful commercial application of microfluidics is the inkjet printhead. In inkjet printing, small droplets of ink are controllably directed toward a recording medium in order to form an image. Although the majority of the market for drop ejection devices is for the printing of inks, other markets are emerging such as ejection of polymers, conductive inks, or drug delivery. Advances in microfluidics technology are also used in recent molecular biology procedures for enzymatic analysis, DNA analysis, and proteomics. Microfluidic biochips integrate assay operations such as detection, as well as sample pre-treatment and sample preparation on one chip. Another emerging application area is biochips in clinical pathology, especially the immediate point-of-care diagnosis of diseases. In addition, microfluidics-based devices, capable of continuous sampling and real-time testing of air/water samples for biochemical toxins and other dangerous pathogens, can provide an always-on early warning.

Many microfluidic devices include a patterned polymer layer on a substrate, such as silicon. The substrate includes one or more inorganic layers formed on a surface of the substrate, where the inorganic layers form structures for operating on the fluid in the microfluidic device in some fashion. The patterned polymer layer includes walls for defining fluid passageways to direct the flow of fluid, or chambers for constraining a small quantity of fluid. The patterned polymer layer is typically formed over the inorganic layer(s). Typical polymer layers are photo-sensitive polyimides and photo-sensitive epoxies. The family of photo-sensitive epoxies called SU-8 is prevalent in microfluidic devices, due to properties such as high stability to chemicals, excellent biocompatibility, and the ability to form high aspect ratio structures such as walls having a greater height than width.

In order to transport fluid to the active side of the device, a feed hole through the substrate is formed. Typically this feed hole is formed by patterning and etching from the back side of the substrate to the device side of the substrate. Conventionally the feed hole is a single large hole. Feed holes of the prior art have been formed in various ways using laser drilling, wet etching, or dry etching of the silicon.

In many cases it is advantageous to etch feed openings from the device side of the substrate. When multiple smaller openings are desired, it is difficult to form them by etching through the substrate from the back side due to the large aspect ratio. In prior art, the patterning of the ink feed holes is performed using back to front wafer alignment of a mask. However there are issues in fabrication that degrade alignment. If the silicon wafer is warped, the ink feed holes will not align precisely with the mask. Also, during the etch process itself the etch direction is not completely perpendicular to the wafer surface, especially approaching the wafer edge, due to directional variation of the ions. It is also difficult to time the etch process so that there is no overetching causing undercut of the silicon wafer at the device side. It is desirable to have a process that self aligns the ink feed hole to the ink chamber.

However, deep feed openings in the device side of the substrate result in high topography which causes problems in the subsequent patterning of fluid passageways. US Patent Application Publication No. 2010/0078407, entitled “Liquid Drop Ejector Having Self-Aligned Through-Wafer Feed”, incorporated herein by reference, describes a method for forming a liquid ejection printhead die containing feed openings formed in the device side of the wafer and using a laminated dry film polymer layer to form the nozzle plate. For some devices it is advantageous to form a polymer layer over a patterned sacrificial resist. Sacrificial resist used to form the fluid passageways is applied in a uniform thickness if the coating surface is substantially planar. If the surface has topographical features such as holes or openings, materials do not tend to coat with uniform thickness, causing variations in the fluid passageway geometry which can affect the performance or final yield of the device.

What is needed is a microfluidic device and a method for making such a microfluidic device having a well defined feed opening etched from the device side of the substrate and a polymer film that is substantially planar in a region that extends over the feed openings for devices in which the polymer film is formed over a sacrificial resist.

### SUMMARY OF THE INVENTION

The present invention is directed to overcoming one or more of the problems set forth above. Briefly summarized, according to one aspect of the invention, the invention resides in a method of fabricating a microfluidic device, the method comprising: providing a substrate including a first side and a second side opposite the first side; etching a plurality of frame-shaped grooves into the first side of the substrate, each frame-shaped groove surrounding a non-etched portion of the substrate; dispensing a sacrificial photoresist on the first side of the substrate; spinning the wafer to obtain a substantially planar surface of the sacrificial photoresist; patterning the sacrificial photoresist to form openings defining walls for a plurality of chambers and fluid passageways; laminating a polymer film over the patterned sacrificial photoresist; etching a portion of the substrate from the second side of the substrate until the etched portion meets the frame-shaped grooves; removing the sacrificial resist to provide a plurality of chambers, each chamber being adjacent to at least one of the plurality of walls; and removing the non-etched portions of the substrate surrounded by the frame-shaped grooves to form a plurality of feed holes.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the detailed description of the preferred embodiments of the invention presented below, reference is made to the accompanying drawings, in which:

FIG. 1 is a schematic representation of an inkjet printer system;

FIG. 2 is a perspective of a portion of a printhead;

FIG. 3 is a perspective of a portion of a carriage printer;

FIG. 4 is a top view of a partial section of a printhead die;

FIG. 5 is a perspective of a partial section of the printhead die;

FIG. 6 is a perspective of a partial section of the printhead die after patterning and etching through at least one inorganic layer;

FIG. 7 is a perspective of a partial section of the printhead die after applying and patterning a photoresist and using an anisotropic dry silicon etch;

FIG. 8 is a perspective of a partial section of the printhead die after coating and patterning a sacrificial photoresist layer on the device side;

FIG. 9A illustrates a blind feed hole that is fully opened with no frame pattern;

FIG. 9B illustrates the sacrificial photoresist layer coated over the frame-shaped groove pattern;

FIG. 10 is a perspective of a partial section of the printhead die after a photoimageable polymer film has been laminated over the sacrificial resist layer;

FIG. 11A is a perspective of a partial section of the printhead die after laminating the sacrificial resist layer with photoimageable polymer film;

FIG. 11B is a partial cross-sectional view taken along line B-B of FIG. 11A;

FIG. 12 is a partial cross-sectional view along line B-B of FIG. 11A after grinding and etching the back side;

FIG. 13 is an alternative embodiment of FIG. 12 where the printhead die is thinned using a patterned etch from the back side;

FIG. 14 is a cross-sectional view after the sacrificial resist is removed; and

FIG. 15 is a cross-sectional view if the completed device.

### DETAILED DESCRIPTION OF THE INVENTION

The present description will be directed in particular to elements forming part of, or cooperating more directly with, apparatus in accordance with the present invention. It is to be understood that elements not specifically shown or described can take various forms well known to those skilled in the art. In the following description, identical reference numerals have been used, where possible, to designate identical elements.

As described in detail herein below, at least one embodiment of the present invention provides a microfluidic device and a method for making such a microfluidic device having well defined feed openings etched from the device side of the substrate and a polymer film that is substantially planar in a region that extends over the feed openings for devices in which the polymer film is formed over a sacrificial resist. The most familiar of such devices are used as printheads in ink jet printing systems. Many other applications are emerging which make use of microfluidic devices for ejecting non-printing materials, or for fluid handling, or for chemical or biological analysis, for example. Although embodiments will be described in the context of inkjet printers, it is contemplated that other types of microfluidic devices will also benefit from well defined openings etched from the device side of the substrate and a polymer film that is substantially planar in a region that extends over the openings for devices in which the polymer film is formed over a sacrificial resist.

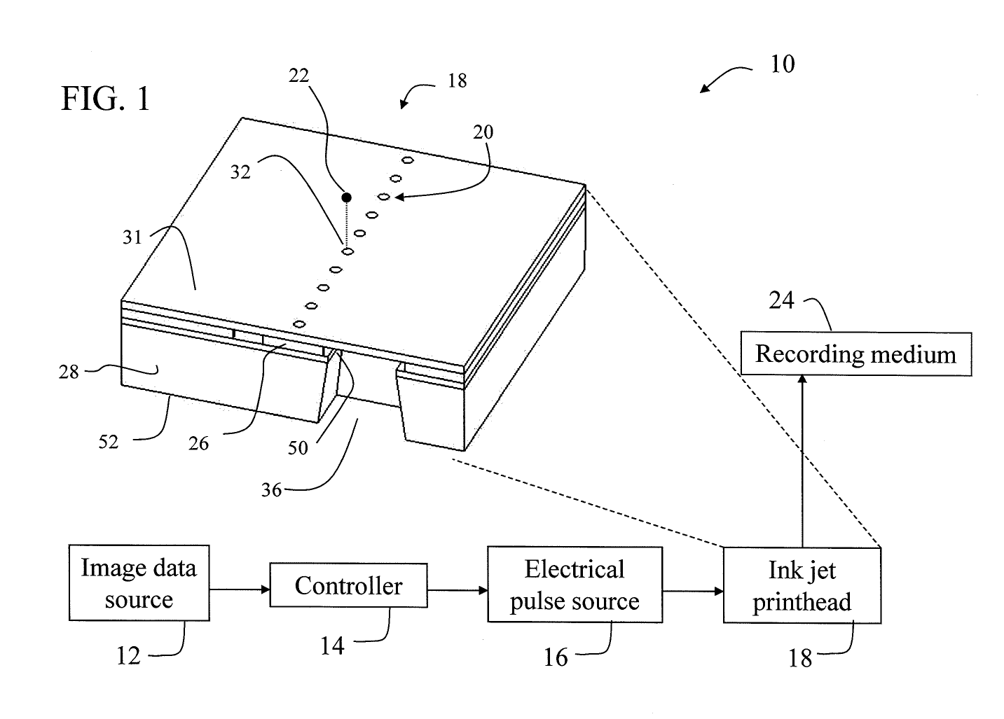

Referring to FIG. 1, a schematic representation of an inkjet printing system 10, utilizing a printhead fabricated according to the present invention, is shown. Inkjet printing system 10 includes a source 12 of data (for example, image data) which provides signals that are interpreted by a controller 14 as commands to eject liquid drops. Controller 14 outputs signals to a source 16 of electrical energy pulses that are sent to liquid ejector printhead die 18, a partial section of which is shown in the figure. Liquid ejector printhead die 18 is an example of a liquid ejection device, which is a type of microfluidic device. Typically, a liquid ejector printhead die 18 includes a plurality of liquid ejectors 20 arranged in at least one array, for example, a substantially linear row on substrate 28. The portion of the liquid ejector 20 that is visible in FIG. 1 is the nozzle(s) 32 in nozzle plate 31. During operation, ink enters a back side 52 of liquid ejector printhead die 18 through feed holes(s) 36 and flows to chamber(s) bounded by wall(s) 26 on device side 50 of substrate 28 from which ink drops 22 are ejected through nozzle orifices 32 and deposited on a recording medium 24. Not shown in FIG. 1, are the drop forming mechanisms associated with the nozzles 32. Drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by heating a bi-layer element) and thereby cause ejection. In any case, electrical pulses from electrical pulse source 16 are sent to the various drop ejectors according to the desired deposition pattern.

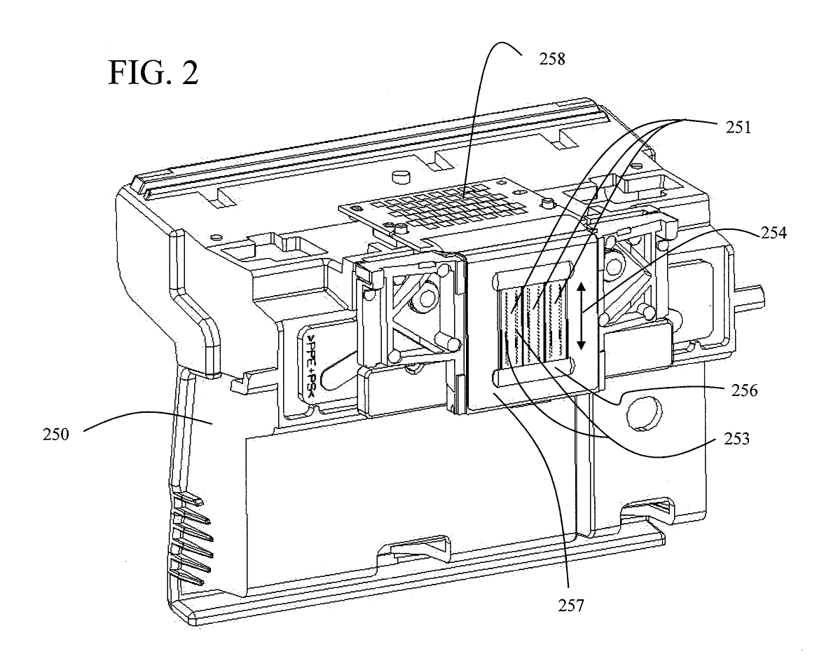

FIG. 2 shows a perspective of a portion of an inkjet printhead 250. Printhead 250 includes three printhead die 251 (similar to liquid ejector printhead die 18 in FIG. 1), each printhead die 251 containing two nozzle arrays 253, so that printhead 250 contains six nozzle arrays 253 altogether. The six nozzle arrays 253 in this example can each be connected to separate ink sources (not shown in FIG. 2); such as cyan, magenta, yellow, text black, photo black, and a colorless protective printing fluid. Each of the six nozzle arrays 253 is disposed along nozzle array direction 254, and the length of each nozzle array along the nozzle array direction 254 is typically on the order of 1 inch or less. Typical lengths of recording media are 6 inches for photographic prints (4 inches by 6 inches) or 11 inches for paper (8.5 by 11 inches). Thus, in order to print a full image, a number of swaths are successively printed while moving printhead 250 across the recording medium 24. Following the printing of a swath, the recording medium 24 is advanced along a media advance direction that is substantially parallel to nozzle array direction 254.

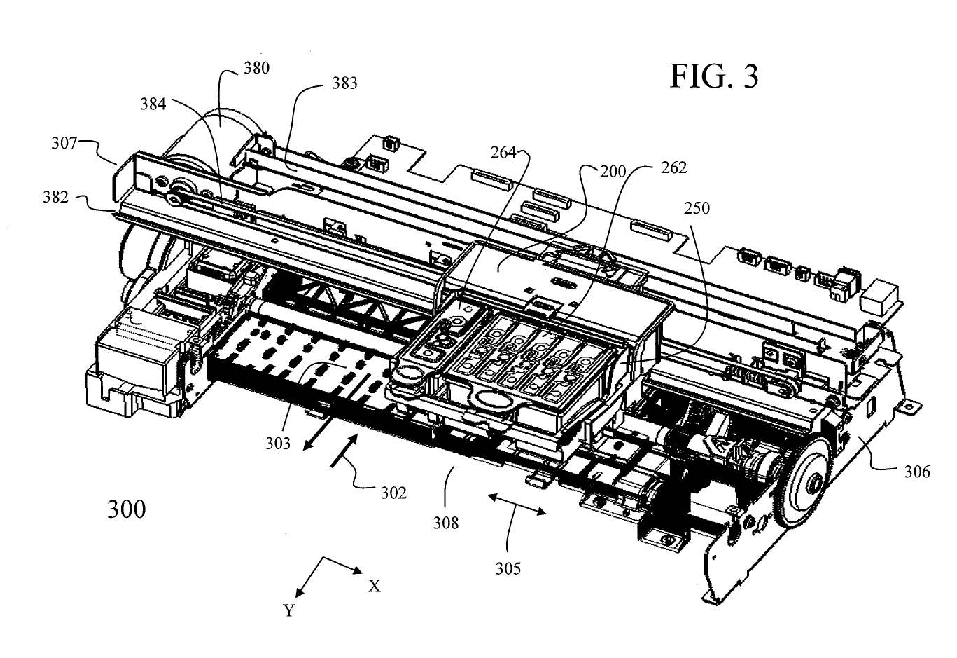

Also shown in FIG. 2 is a flex circuit 257 to which the printhead die 251 are electrically interconnected, for example, by wire bonding or TAB bonding. The interconnections are covered by an encapsulant 256 to protect them. Flex circuit 257 bends around the side of printhead chassis 250 and connects to connector board 258. When printhead 250 is mounted into the carriage 200 (see FIG. 3), connector board 258 is electrically connected to a connector (not shown) on the carriage 200, so that electrical signals can be transmitted to the printhead die 251.

FIG. 3 shows a portion of a desktop carriage printer. Some of the parts of the printer have been hidden in the view shown in FIG. 3 so that other parts can be more clearly seen. Printer chassis 300 has a print region 303 across which carriage 200 is moved back and forth in carriage scan direction 305 along the X axis, between the right side 306 and the left side 307 of printer chassis 300, while drops are ejected from printhead die 251 (not shown in FIG. 3) on printhead chassis 250 that is mounted on carriage 200. Carriage motor 380 moves belt 384 to move carriage 200 along carriage guide rail 382. An encoder sensor (not shown) is mounted on carriage 200 and indicates carriage location relative to an encoder fence 383.

Printhead 250 is mounted in carriage 200, and multi-chamber ink supply 262 and single-chamber ink supply 264 are mounted in printhead 250. The mounting orientation of printhead 250 is rotated relative to the view in FIG. 2, so that the printhead die 251 are located at the bottom side of printhead 250, the droplets of ink being ejected downward onto the recording medium in print region 303 in the view of FIG. 3. Multi-chamber ink supply 262, in this example, contains five ink sources: cyan, magenta, yellow, photo black and colorless protective fluid; while single-chamber ink supply 264 contains the ink source for text black. Typically, the inks are aqueous based inks. The inks can include dye-based colorants or pigmented colorants. Paper or other recording medium is loaded along paper load entry direction 302 toward the front of printer chassis 308. A variety of rollers move the recording medium through the printer.

US Patent Application Publication No. 2010/0078407, entitled “Liquid Drop Ejector Having Self-Aligned Through-Wafer Feed”, incorporated herein by reference, describes a method for forming a liquid ejection printhead die containing feed openings formed in the device side of the wafer using a laminated dry film polymer layer to form the nozzle plate.

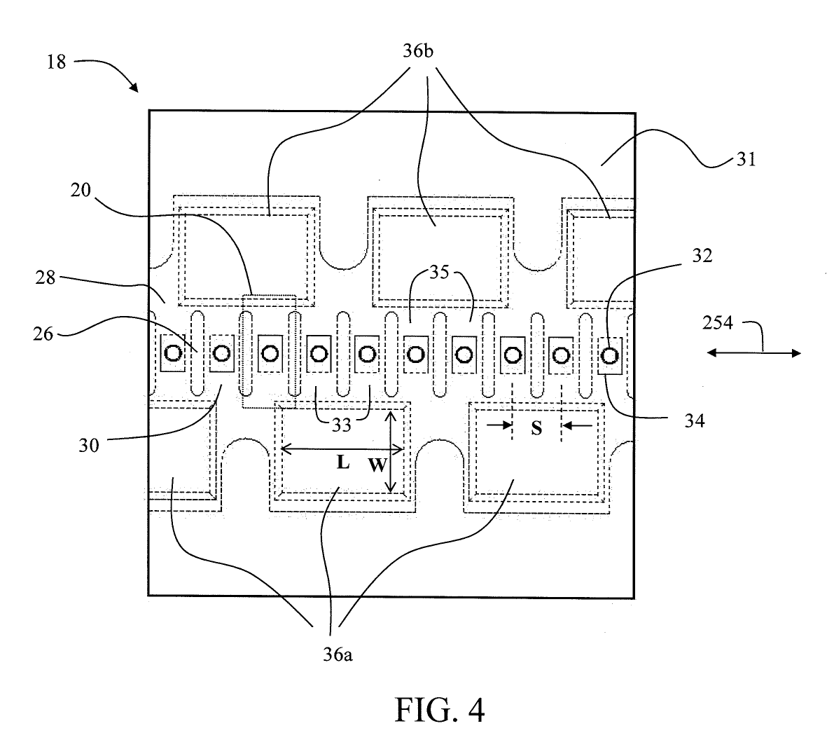

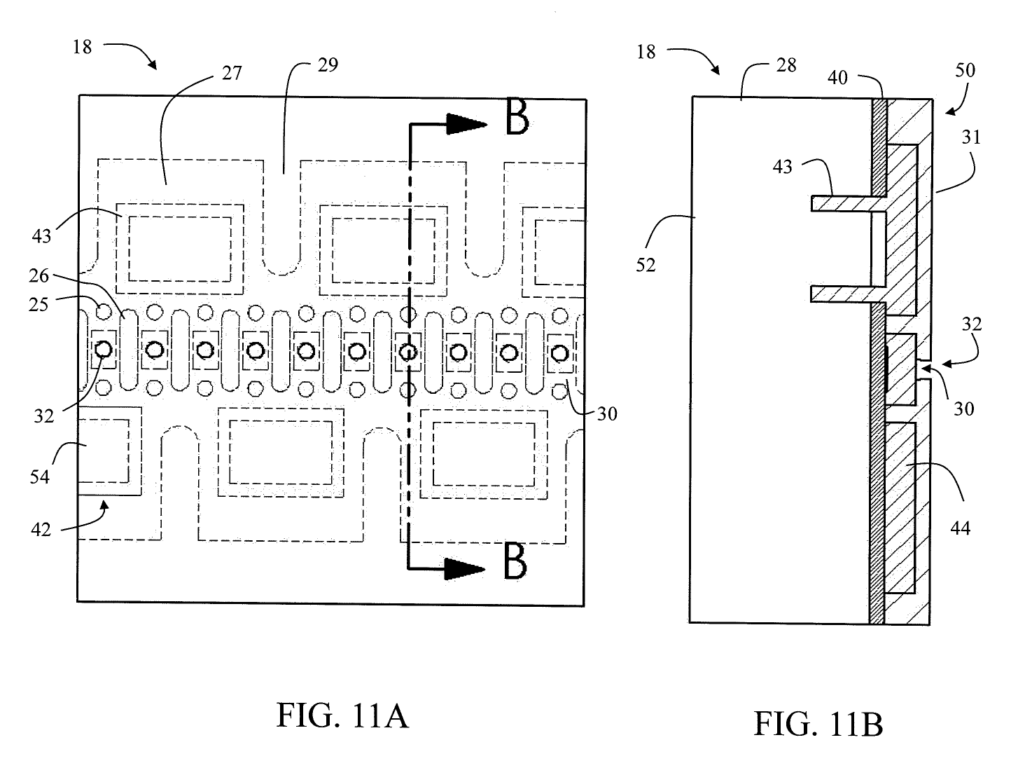

Described in the present invention is an alternative process using a sacrificial resist layer to form fluid passageways over which walls and a nozzle plate are formed with a polymer film. Referring to FIG. 4, a schematic representation of a top view of a partial section of a liquid ejector printhead die 18 for ink is shown. Liquid ejection printhead die 18 includes an array or plurality of liquid ejectors 20, one of which is designated by the dotted line in FIG. 4. Liquid ejector 20 includes a structure, for example, having walls 26 extending from a substrate 28 that define a chamber 30 for holding a liquid, such as ink, prior to ejection of a droplet. The height of wall 26 is typically between 0.5 microns and 20 microns. Walls 26 do not need to totally enclose chamber 30. In the example shown in FIG. 4, chamber 30 is open at both ends. In other inkjet chamber configurations (not shown), walls can define 3 sides of the chamber. In still other microfluidic devices, walls 26 can totally surround a chamber. Furthermore, in addition to walls 26 corresponding to chambers 30, and referring briefly to FIG. 11A, fluid passageway walls 29 can define one or more fluid passageways 27 for a liquid to flow along. In any case, at least one wall defines a location for a fluid in the microfluidic device. Walls 26 separate chambers 30 positioned adjacent to other chambers 30. Each chamber 30 includes a nozzle orifice 32 in nozzle plate 31 through which liquid is ejected. A drop forming element, for example, a resistive heater 34 is also at least partially enclosed in each chamber 30. In FIG. 4, the resistive heater 34 is positioned on the device side of substrate 28 in the bottom of chamber 30 and opposite nozzle orifice 32, although other configurations are permitted.

In the exemplary dual feed configuration of FIG. 4, feed holes 36 include two linear arrays of feed holes 36a and 36b that supply liquid to the chambers 30 from two opposite sides. Feed holes 36a and 36b are positioned on opposite sides of the liquid ejector 20 containing chamber 30 and nozzle orifice 32. Feed holes 36a, 36b can have a length L or width W dimension that is greater than ten microns. If the center to center spacing between a first chamber 30 and an adjacent chamber 30 is S along nozzle array direction 254, then a dimension of an opening of feed hole 36 along nozzle direction 254 can be greater than S. In FIG. 4 the feed holes 36a, 36b are arranged so that a feed hole 36a is located primarily adjacent a first pair 33 of chambers 30 and a feed hole 36b is located primarily adjacent a neighboring second pair 35 of chambers 30 in the printhead array. Feed hole 36a feeds liquid not only to first pair 33 of chambers 30, but also at least to the neighboring chamber that is also fed by feed hole 36b from the opposite side. Such an array of feed holes 36 permits a configuration including feed holes 36 for ink, as well as land areas for supporting electrical leads (not shown) that connect to resistive heaters 34. Other dual feed geometries are also possible as disclosed in U.S. Pat. No. 7,857,422 and incorporated herein by reference. Still other liquid ejector printhead die configurations only contain a single feed hole that extends along the array of chambers in order to provide ink to them. In general, for other types of microfluidic devices some way of introducing fluid to the device is required. This can include one or more feed holes 36 that pass through substrate 28 (see FIG. 1), thereby permitting passage of a liquid from a back side 52 of substrate 28 to a device side 50.

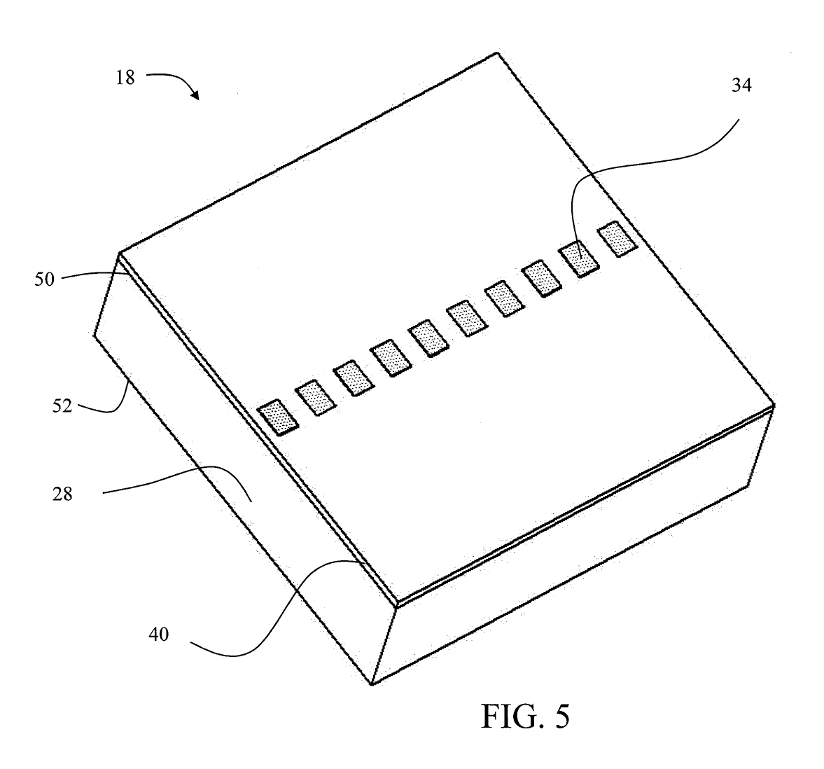

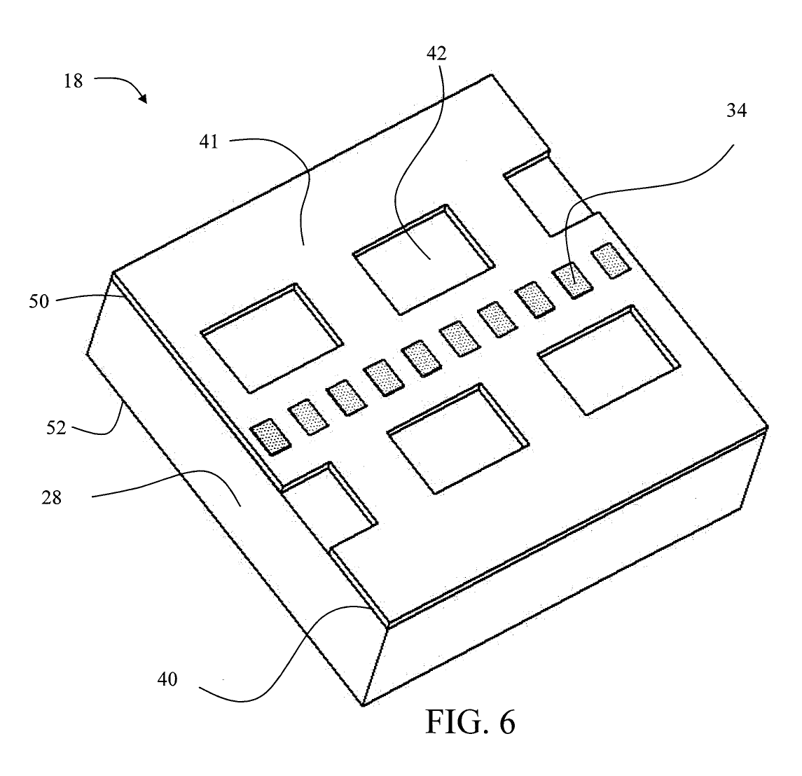

FIGS. 5-14 illustrate a fabrication method of an exemplary embodiment of the present invention for forming a liquid ejection printhead die 18 having feed openings 42 etched from the device side 52 of the substrate 28 using a sacrificial resist layer 44 to form liquid passageways for inks. Many liquid ejection printhead die 18 are formed on the substrate 28 (a portion of one of which is shown), which is typically a silicon wafer. As shown as a partial section of a liquid ejection printhead die 18 in FIG. 5 a plurality of drop forming elements, in this example, an array of resistive heaters 34 is formed on top of an inorganic layer 40, typically a silicon oxide layer that is formed on a device side 50 of the silicon substrate 28. Fabricated in the liquid ejection printhead 18, but not shown, are electrical connections to the resistive heaters 34, as well as power LDMOS transistors and CMOS logic circuitry to control drop ejection. A silicon nitride layer can be deposited over the resistive heaters 34, as well as over other parts of the liquid ejection printhead die. A layer of tantalum can be deposited over at least portions the silicon nitride layer, especially over the resistive heaters 34 in order to provide additional protection against ink. In other words, at least one inorganic layer 40 is provided on substrate 28. Inorganic layer(s) 40 can include silicon, silicon oxide, silicon nitride, tantalum, and metal for circuitry (typically aluminum). One or more of these materials can be disposed at the surface 41 (FIG. 6) of inorganic layer 40.

FIG. 6 shows a partial section of a liquid ejection printhead die 18 after patterning and etching through the inorganic layer(s) 40 to the silicon substrate 28 forming feed openings 42 in the inorganic layer(s) 40. In some embodiments, a thin polymer layer (not shown), such as an epoxy layer (for example a 0.5 micron to 5 micron thick layer of TMMR resist available from Tokyo Ohka Kogyo) is formed over the entire surface 41 in FIG. 6 and then is patterned away from the feed openings 42 in the inorganic layer 40 and the resistive heaters 34 so that it does not cover those regions. Similarly, it would also be patterned away from the bond pads (not shown) of the device. Such a configuration can provide improved adhesion of walls 26 and other features, as discussed below and in co-pending and commonly assigned U.S. application Ser. No. 13/170,693.

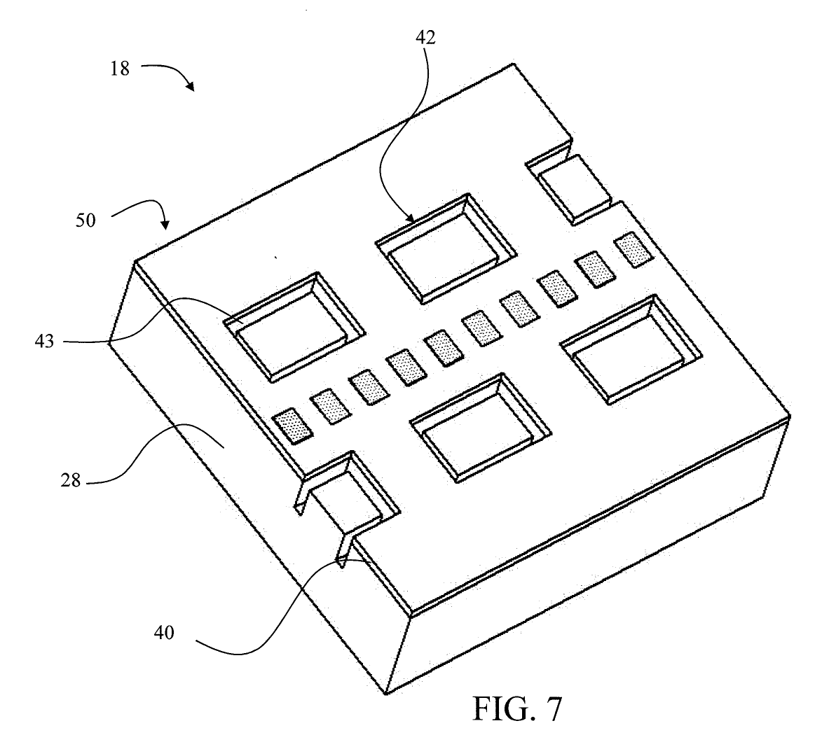

FIG. 7 shows a partial section of a liquid ejection printhead die 18 after applying and patterning a photoresist (not shown) and using an anisotropic dry silicon etch to etch a frame-shaped groove 43 in the silicon substrate 28 from the device side 50 of the substrate 28 in each of the feed openings 42 of inorganic layer(s) 40. Since the frame pattern is aligned to the feed openings 42 from the front of the wafer, alignment accuracy is very good. Alternatively, since the inorganic layer(s) 40 has a high selectivity to the anisotropic dry silicon etch, it can be used as a masking material with the resist pattern pulled back 0.5-2 μm from the edge of the feed opening 42 so that the pattern of the frame shaped groove 43 is self aligned to the feed openings 42. There is no etch stop and etching is timed to provide a blind frame-shaped groove 43 having a depth in the range 30-300 microns and a cross-sectional groove width that is typically less than 10 microns. The equipment for the anisotropic dry silicon etch (e.g. deep reactive ion etching) is commercially available from etching equipment manufacturing companies.

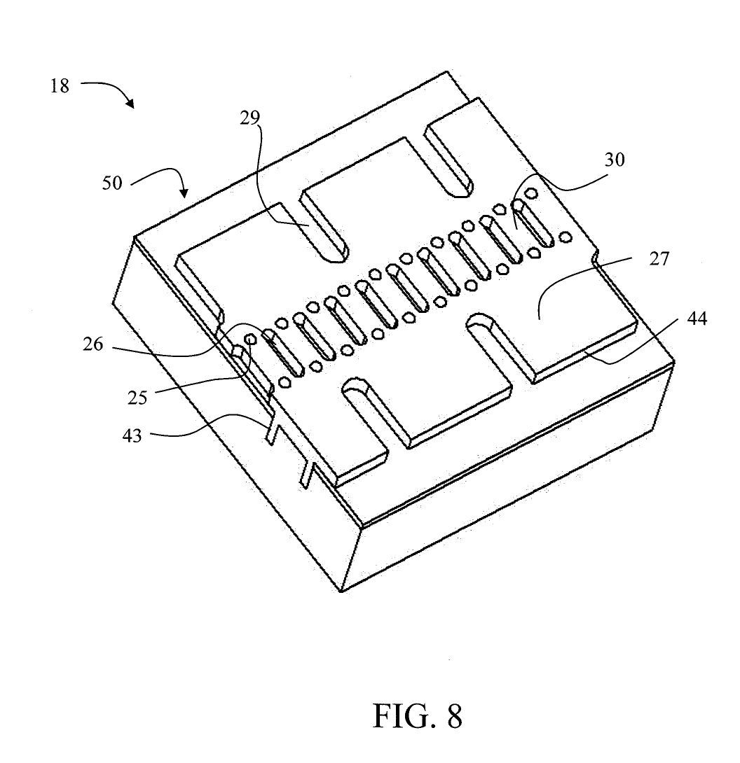

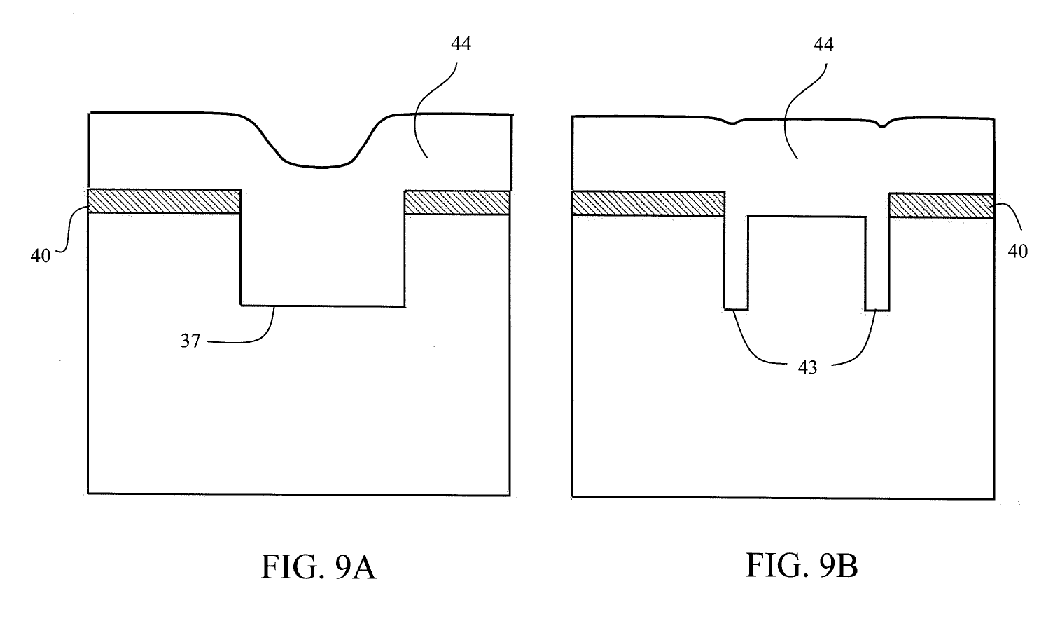

FIG. 8 shows a partial section of a liquid ejection printhead die 18 after coating and patterning a sacrificial photoresist layer 44 on device side 50 of substrate 28. Sacrificial resist layer 44 is coated by dispensing liquid photoresist material and spinning the wafer to obtain a substantially planar surface of the sacrificial resist 44. The width of the frame-shaped groove 43 is designed to reduce the non-uniform topography on surface of the sacrificial resist layer 44. As an example, FIG. 9A illustrates a blind feed hole 37 that is fully opened with no frame pattern. The sacrificial resist layer 44 tends to conform to the underlying topography as the solvent contained in the resist to enable spin coating of the material is removed. This creates large deviation from planarity on the surface of the sacrificial resist 44 in the form of a large dip located over blind feed hole 37. By contrast, FIG. 9B illustrates the sacrificial photoresist layer 44 coated over the frame-shaped groove 43 pattern. The smaller openings of the groove topography result in a much smoother top surface of the sacrificial resist 44. As shown in FIG.9B the frame-shaped groove 43 substantially filled with the sacrificial resist layer 44. Otherwise trapped air can cause defects in the sacrificial resist layer during baking steps.

As an example two substrates were fabricated containing feed holes 36. Feed holes 36 on both substrates had square outer openings 50 um×50 um etched from the device side 50 to a depth of 70 microns. The first substrate had feed holes 36 including a blind feed hole 37 formed similar to the one depicted in FIG. 9A. The second substrate had feed holes 36 formed by etching a frame-shaped groove 43 similar to the one depicted in FIG. 9B where the frame-shaped groove 43 had a width of 6 microns. Both substrates were coated with a 12 micron layer of sacrificial resist. The substrate with feed holes 36 having a blind feed hole similar to the one depicted in FIG. 9A had a surface topography variation in the area of the feed openings 42 of 9 microns. The substrate with feed holes 36 formed by using the frame-shaped groove 43 similar to those depicted in FIG. 9B had a surface topography variation in the area of the feed openings 42 of one micron. For other frame geometries the topography variations in the area of the feed openings 42 can be greater than one micron or less than one micron, but in many embodiments, the sacrificial resist layer 44 will advantageously have a topography variation of not greater than three microns.

The sacrificial resist layer 44 shown in FIG. 8 is patterned to define the fluid passageways 27 and the chambers 30. The sacrificial resist layer 44 contains openings to define the chamber walls 26, pillars 25, and fluid passageway walls 29 which will be subsequently filled with a polymer layer. The sacrificial resist layer 44 is photoimageable and can be a standard novolak-based resist which is commercially available. The thickness of the sacrificial resist layer 44 is typically 5-30 microns.

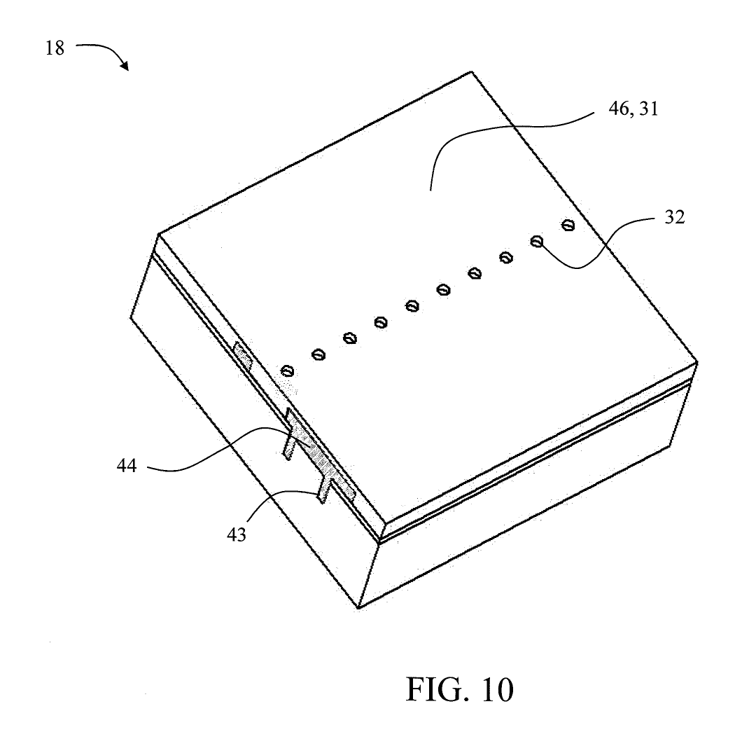

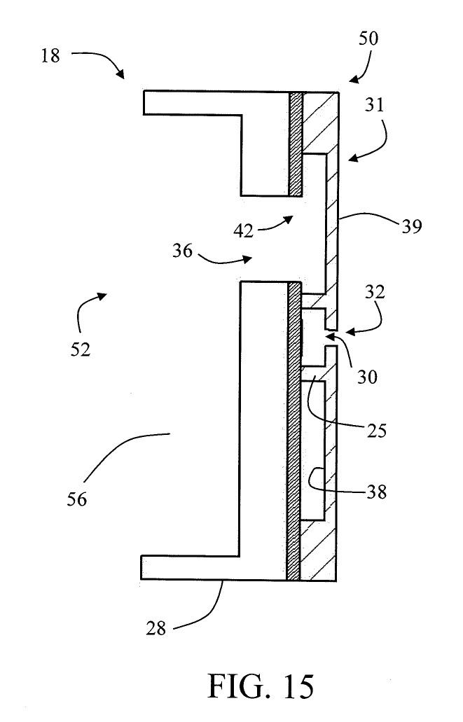

FIG. 10 shows a partial section of a liquid ejection printhead die 18 after a photoimageable polymer film 46 has been laminated over sacrificial resist layer 44 and provides a nozzle plate layer 31 that has been patterned by exposure through a mask and subsequent development to form nozzles 32. During formation of the nozzles some or all of the sacrificial resist layer 44 can also be removed. The thickness of the photoimageable nozzle plate layer 31 layer is in the range 5-15 microns and in a preferred embodiment is 10 microns (i.e. it is typically thicker than the thin polymer layer discussed above relative to FIG. 6). The photoimageable polymer film 46 is a dry film photoimageable epoxy such as a novolak resin based epoxy, for example TMMF dry film resist which is commercially available. Laminating the dry film resist at temperatures higher than the flow temperature of the polymer film combined with a post lamination bake enables the polymer layer 44 to deform around the patterned sacrificial resist 44 and fill in the openings in the sacrificial resist 44 to create pillars 25, chamber walls 26, and outer fluid passageway walls 29. Because the sacrificial resist 44 has been provided with a surface topography variation of not greater than three microns in a region near the frame shaped grooves 43, the laminated polymer film 46 also has a topography variation of not greater than three microns. For embodiments where the sacrificial resist 44 has a surface topography of not greater than one micron (as was provided in the example discussed above relative to FIG. 9B) the laminated polymer film also has a topography variation of not greater than one micron. In particular, because the surface of the laminated polymer film 46 that is in contact with the sacrificial resist 44 conforms to the shape of the sacrificial resist 44, the planarity improvement that is provided is on a first side 38 (FIG. 15) of the nozzle plate 31 that forms the tops of the chambers 30 and fluid passageways 27.

FIG. 11B shows a partial cross-section of a liquid ejection printhead die 18 taken along line B-B as shown in FIG. 11A. The polymer film 46 forms nozzle plate layer 31 and has filled in the openings in the sacrificial resist layer 44 to form pillars 25, walls 26 (not shown in FIG. 11B), and fluid passageway walls 29 with chambers 30 and fluid passageways 27 formed by the sacrificial resist 44.

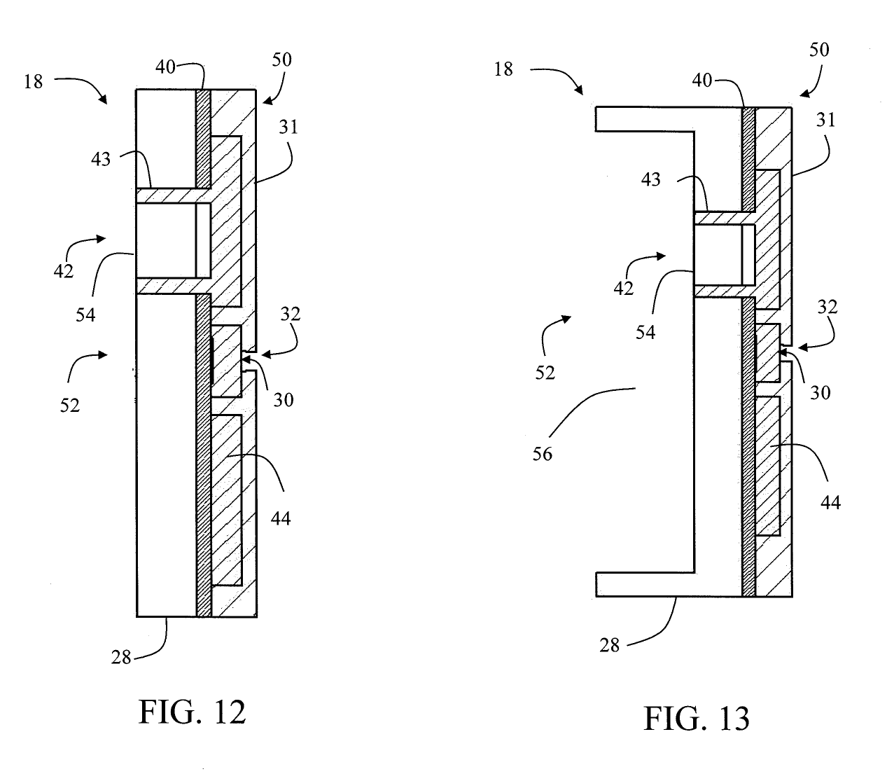

In a first embodiment of the present invention, the substrate 28 containing liquid ejection printhead die 18 is then mounted on a tape frame and the back side of the substrate 28 is removed by a combination of grinding and wet and dry etching to uncover the feed openings 42. FIG. 12 show a partial cross-section of a liquid ejection printhead die 18 taken along line B-B as shown in FIG. 11A. Each of the feed openings 42 contain a block 54 of non-etched material of substrate 28 with boundaries defined by the frame-shaped groove 43 and held in place by the sacrificial resist 44 surrounding it. In a preferred embodiment of the present invention the back side 52 of substrate 28 is ground to within a distance t of 0-40 microns of the feed openings 42. In a preferred embodiment the distance t is approximately 20 microns for the following reasons. Firstly the grinding process can leave residue in the feed openings if the grinding process is used to fully open the feed lines. Secondly the grinding process typically results in microcracks causing damage for a thickness of 10-20 microns deep into the substrate 28. This damage will cause a weakness of the substrate 28 resulting in cracking if not removed. In this case the substrate 28 is then left on the tape frame with its back side 52 exposed unmasked to a plasma containing etchant gas sulfur hexafluoride. Such blanket etch systems are commercially available from, for example, TEPLA and are used to remove damage in the silicon substrate after grinding. The system is maintained so that the substrate temperature stays below 70 degrees C. This ensures that the tape frame will not be affected and the chamber 30 and nozzle plate layer 31 polymer film 46 will not be etched. This system performs a blanket etch (e.g. by deep reactive ion etching) on the substrate 28, removing silicon from the substrate 28 until the etched portion meets the frame-shaped grooves 43 so that the feed openings 42 are exposed. The advantages of this method are as follows. First, the etch provides clean opening of the feed openings 42 with no residue. Second, damage that was formed during wafer grinding is removed by this step, as is well known in the art. Third, the substrate 28 is mounted on a tape frame so handling of a thin wafer is much easier. Fourth, no patterning of the substrate back is necessary making the process much simpler. The substrate 28 can be taken from this step straight to dicing so that handling of thin wafers is reduced. The final thickness of the silicon substrate 28 in a preferred embodiment is in the range 30-300 microns.

In a second embodiment of the present invention, the substrate 28 containing liquid ejection printhead die 18 is patterned on the back side 52 of the substrate 28 and etched using an anisotropic dry silicon etch to uncover the feed openings 42. In this case the thin substrate area is confined to the ejector region of the liquid ejection printhead die 18 as shown in FIG. 13. The thinned area includes a trench 56 in the back side 52 of substrate 28. Trench 56 is in fluid communication with the plurality of feed openings 42.

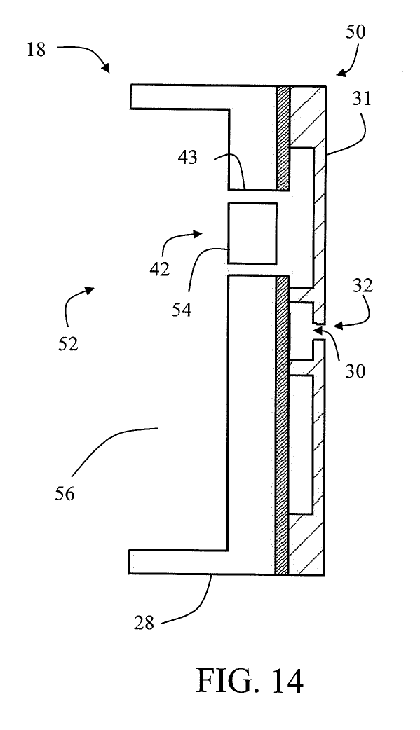

Sacrificial resist 44 is then removed as shown in FIG. 14 by soaking the substrate in a suitable solvent such as PGMEA. The sacrificial resist layer 44 adheres the blocks 54 to the feed openings 42 and by removing the sacrificial resist 44 permits them to fall out as shown in FIG. 15. To aid in the removal of the blocks 54, vibrational energy such as megasonic energy can be applied to agitate the liquid solvent bath during sacrificial resist removal. Further removal of the blocks 54 can be accomplished by mechanical shaking of the substrate 28 or applying a vacuum after sacrificial resist removal.

In the completed device shown in partial section in FIG. 15, the polymer film forms nozzle plate 31, walls 26, and fluid passageway walls 29. Nozzle plate 31 includes a first side 38 forming the tops of chambers 30 and fluid passageways 27, and second side 39 is opposite first side 38. First side 38 of nozzle plate 31 defines a nominally planar surface and does not deviate from the nominally planar surface by more than three microns in a region near feed openings 42 of feed holes 36. Pillars 25, which can also be formed by the polymer film, extend from first side 38 of nozzle plate 31 toward device side 50 of substrate 28. In some embodiments, pillars 25 are adhered to device side 50 of substrate 28.

The invention has been described in detail with particular reference to certain preferred embodiments thereof, but it will be understood that variations and modifications can be effected within the spirit and scope of the invention.

### PARTS LIST

10 Liquid ejection system
12 Data source
14 Controller
16 Electrical pulse source
18 Liquid ejection printhead die
20 Liquid ejector
22 Ink drop
24 Recording medium
25 Pillar
26 Wall
27 Fluid passageway
28 Substrate
29 Fluid passageway wall
30 Chamber
31 Nozzle plate layer
32 Nozzle
33 First pair
34 Resistive heater
35 Second pair
36 Feed hole
36a, 36b Feed holes
37 Blind feed hole
38 First side (of nozzle plate)
39 Second side (of nozzle plate)
40 Inorganic layer
41 Surface
42 Feed opening
43 Frame-shaped grooves
44 Sacrficial resist
45 Polymer film
46 Device side
52 Back side
54 Block
56 Trench
200 Carriage
250 Printhead chassis
251 Printhead die
253 Nozzle array
254 Nozzle array direction
256 Encapsulant
257 Flex circuit
258 Connector board
262 Multi-chamber ink supply
264 Single-chamber ink supply
300 Printer chassis
302 Paper load entry direction
303 Print region
304 Media advance direction
305 Carriage scan direction
306 Right side of printer chassis
307 Left side of printer chassis
308 Front of printer chassis
309 Rear of printer chassis
380 Carriage motor
382 Carriage guide rail
383 Encoder fence
384 Belt
X, Y Axis
L Length
S Dimension
W Width

1. A method of fabricating a microfluidic device, the method comprising:
providing a substrate including a first side and a second side opposite the first side;
etching a plurality of frame-shaped grooves into the first side of the substrate, each frame-shaped groove surrounding a non-etched portion of the substrate;
dispensing a sacrificial photoresist on the first side of the substrate;
spinning the wafer to obtain a substantially planar surface of the sacrificial photoresist;
patterning the sacrificial photoresist to form openings defining walls for a plurality of chambers and fluid passageways;
laminating a polymer film over the patterned sacrificial photoresist;
etching a portion of the substrate from the second side of the substrate until the etched portion meets the frame-shaped grooves;
removing the sacrificial resist to provide a plurality of chambers, each chamber being adjacent to at least one of the plurality of walls; and
removing the non-etched portions of the substrate surrounded by the frame-shaped grooves to form a plurality of feed holes.

2. The method according to claim 1, wherein the step of etching the plurality of frame shaped grooves includes deep reactive ion etching.

3. The method according to claim 1, wherein the step of etching a portion of the substrate from the second side of the substrate includes deep reactive ion etching.

4. The method according claim 1, wherein the step of laminating the polymer film further includes deforming the polymer film around the sacrificial resist.

5. The method according to claim 4, wherein the step of laminating the polymer film further includes deforming the polymer film at an elevated temperature.

6. The method according to claim 4, wherein the step of forming the plurality of walls on the first side of the substrate is at least partially coincident with the step of deforming the polymer film around the sacrificial resist.

7. The method according to claim 6, wherein the step of forming the plurality of walls on the first side of the substrate further includes depositing and patterning a polymer layer on the first side of the substrate before the step of laminating the polymer film, and wherein the polymer layer is thinner than the polymer film.

8. The method according to claim 7, wherein the polymer layer and the polymer film are both epoxy.

9. The method according to claim 1, wherein the feed openings have a cross sectional dimension that is greater than 10 microns.

10. The method according to claim 1, wherein a depth of the frame-shaped grooves is greater than 30 microns.

11. The method according to claim 1, wherein a cross-sectional width of the frame-shaped grooves is less than 10 microns.

12. The method according to claim 1, wherein the step of removing the non-etched portions of the substrate further includes applying a vibration to the substrate.

13. The method according to claim 1, wherein the step of removing the non-etched portions of the substrate further includes agitating a liquid in contact with the substrate.

14. The method according to claim 1, wherein the step of removing the non-etched portions of the substrate further includes applying a vacuum to the second side of the substrate.

16. The method according to claim 1, the step of patterning the sacrificial photoresist further comprising forming a hole through the sacrificial photoresist in a region not corresponding to the walls.

17. The method according to claim 1, wherein the step of laminating the polymer film further includes deforming a portion of the polymer film through the hole in the sacrificial resist at an elevated temperature in order to form a pillar extending from the polymer film.

18. The method according to claim 1, the microfluidic device comprising a liquid ejection device, the method further comprising:
forming a plurality of resistive heaters on the first side of the substrate; and
forming a plurality of nozzles in the polymer film, each of the plurality of nozzles being located proximate a corresponding resistive heater.

19. The method according to claim 18, wherein the polymer film is photosensitive, and the step of forming a plurality of nozzles further includes exposing the polymer film through a mask and developing the exposed polymer film.
